(19) United States
(12) Patent Application Publication
(10) Pub. No.: US 2017/0180464 A1
(43) Pub. Date: Jun. 22, 2017

(54) Evaluating The Efficacy Of An Advertisement Campaign

(71) Applicant: Blis Media Limited, London (GB)

(72) Inventors: Gregor Donald ISBISTER, London (GB); Davide ANASTASIA, London (GB); Elena YEGOROVA, Greenhithe (GB); Guy NEEDHAM, London (GB)

(21) Appl. No.: 15/452,011

(22) Filed: Mar. 7, 2017

Related U.S. Application Data
(63) Continuation-in-part of application No. 15/336,023, filed on Oct. 27, 2016.
Application No. 15/336,023 is a continuation of application No. 13/857,338, filed on Apr. 5, 2013, now abandoned.

(30) Foreign Application Priority Data
Apr. 5, 2012 (GB) 12 06 254.3

(51) Int. Cl. H04L 29/08; H04L 12/26

(52) U.S. Cl. CPC H04L 67/10; H04L 43/04; H04L 43/08

(57) ABSTRACT

Methods for A/B testing to evaluate the efficacy of an advertisement campaign are disclosed. An advertisement request is received via an IP network from a publisher connected to the IP network. The advertisement request comprises information including a device identifier of a device requesting a resource from the publisher over the IP network. A determination is made to respond to the advertisement request or not on the basis of the information in the advertisement request. In response to determining to respond to the advertisement request, a hash of the device identifier is evaluated to determine whether the device belongs to a control group or not. In response to determining that the device belongs to the control group, no response is made to the advertisement request.

### CROSS REFERENCE TO RELATED APPLICATIONS

This application is a continuation-in-part of U.S. application Ser. No. ______ filed ______ (Attorney Docket No. 4113-P102-US-2), which is a continuation of U.S. application Ser. No. 13/857,338 filed Apr. 5, 2013 (now abandoned), and which claim priority from United Kingdom Patent App. No. 12 06 254.3 filed Apr. 5, 2012, now United Kingdom Patent No. 2 500 936. The whole contents of each of the above-identified applications are incorporated herein by reference in their entirety.

### BACKGROUND OF THE INVENTION

1. Field of the Invention

This invention relates to evaluating the efficacy of an advertisement campaign by performing A/B testing.

2. Description of the Related Art

Location-based services are becoming increasingly commonplace methodologies for delivering content to users, particular those who use mobile devices. In particular, publishers (also known as content providers) commonly wish to provide users with more relevant content in view of their current location—examples of such content being bespoke, dynamically-generated copy specific to a particular location, and advertising. For instance, a publisher may produce regional or even city-based news stories, and may wish to know a user's present location such that they are presented with relevant news. Advertising may need to be presented on a location-specific basis—it would be no good, say, for a user browsing a web page in a first city to be presented with advertising for events occurring in a second city.

Whilst many mobile devices are now location-aware, which is to say they have Global Positioning System (GPS) or similar functionality, and can therefore generate geolocation data, only a small fraction actually give up this data to third parties.

It is therefore desirable to take measures to associate geolocation data with other data that is always provided by mobile devices.

### BRIEF SUMMARY OF THE INVENTION

The present invention is directed towards performing A/B testing to evaluate the efficacy of an advertisement campaign, in which advertisements are shown to users of devices connected to an Internet Protocol (IP) network

The method of the present invention comprises receiving an advertisement request via the IP network from a publisher connected to the IP network. The advertisement request comprises information including a device identifier of a device requesting a resource from the publisher over the IP network.

A determination as to whether to respond to the advertisement request or not on the basis of the information in the advertisement request.

In response to determining to respond to the advertisement request, a hash of the device identifier is evaluated to determine whether the device belongs to a control group or not. In response to determining that the device belongs to the control group, no response is made to the advertisement request.

The present invention therefore allows a comparison to be made between the effect on users of devices to whom advertisements were shown, and users to whom the advertisements were not shown. The method is deterministic, and may therefore be implemented on substantially similar apparatus separated geographically with no need to synchronize state between them.

### BRIEF DESCRIPTION OF THE DRAWINGS

FIG. 1 shows an environment in which the present invention can be used;

FIG. 2 is an illustration of the scarcity of requests from browsing clients that contain geolocation data;

FIG. 3 shows a Real Time Bidding (RTB) environment;

FIG. 4 shows an example of an apparatus for implementing the present invention;

FIG. 5 shows procedures carried out by the RTB computer 401; and

FIG. 6 shows procedures carried out to take the hash of a device ID in step 503.

### DETAILED DESCRIPTION OF EXAMPLE EMBODIMENTS

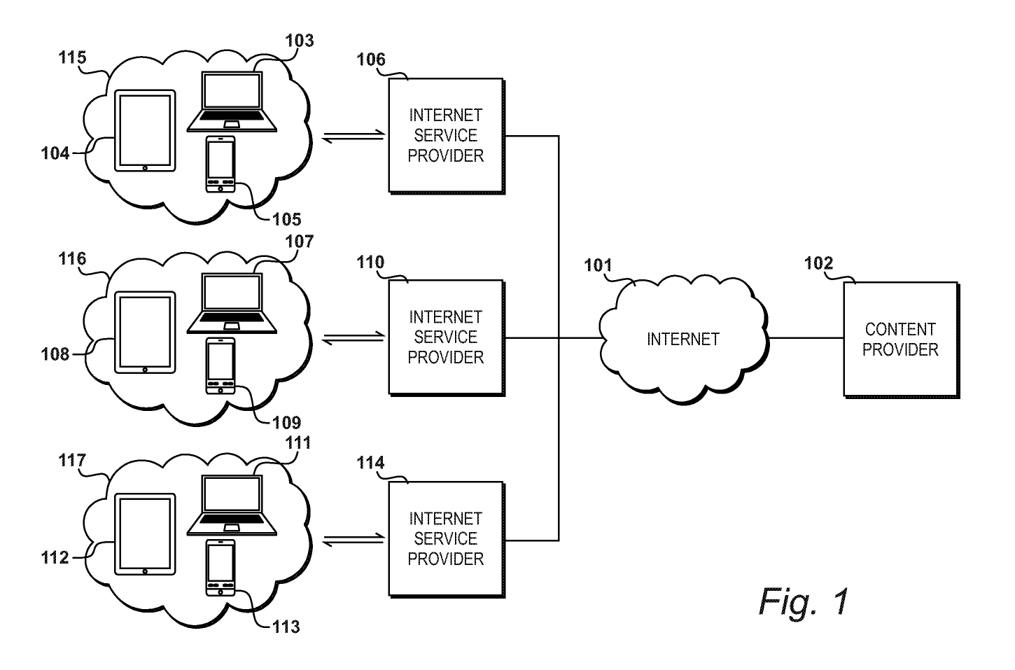

### FIG. 1

An exemplary environment in which the present invention may be used is illustrated in FIG. 1.

Connected by an Internet Protocol (IP) network such as the

Internet 101, are a publisher 102, which provides web content such as web pages, videos and images, and a number of client devices. Each client device, in this case, is connected via an internet service provider (ISP) using wireless networking technologies, such as 802.11b/g. Thus, client devices 103, 104 and 105 are connected to the Internet 101 by means of ISP 106; client devices 107, 108 and 109 are connected to the Internet 101 by means of ISP 110; and client devices 111, 112 and 113 are connected to the Internet 101 by means of ISP 114. In this example, each of ISPs 106, 110 and 114 provides Internet access to connected client devices at a particular location. Thus, client devices 103, 104 and 105 may be connecting to ISP 106 at a hotel, for instance. This type of service is commonly referred to as a “wireless hotspot”, and thus creates wireless hotspots 115, 116 and 117, with ISPs offering Internet access to client devices so as to allow web browsing, email access and so on. In this example, ISP 106 provides Internet access to client devices at a location distinct from ISP 110, ISP 110 provides Internet access to client devices at a location distinct from ISP 114, and so on.

There has recently become a demand for location-aware content. For instance, users may wish to receive content that is only relevant to them in their present location. Furthermore, publishers themselves may only wish to provide particular content to client devices at particular locations. A further need for location-aware generation of content exists in terms of not providing content to users in particular locations, thus allowing a greater degree of control over the distribution of content.

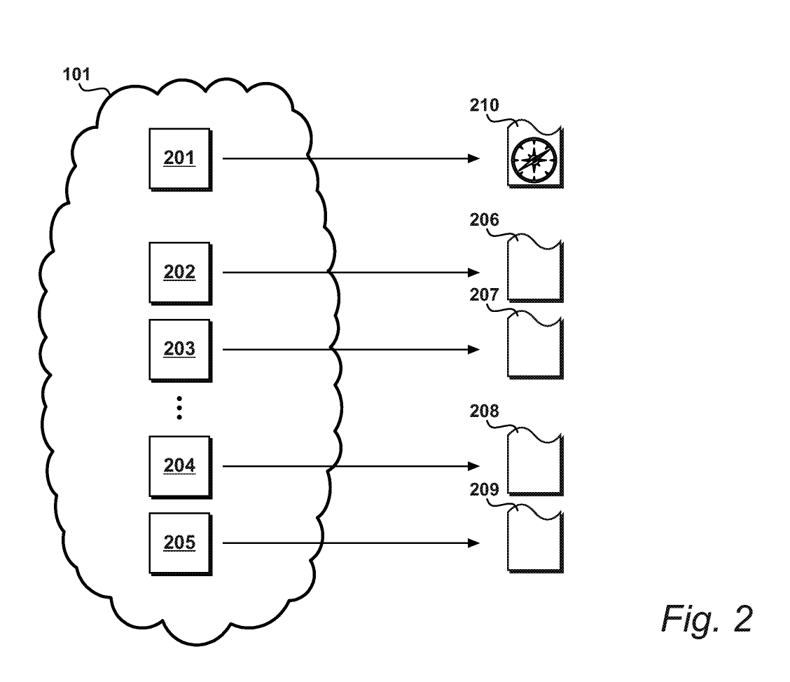

### FIG. 2

As will be appreciated by those skilled in the art, not all client devices have functionality that allows the provision, to a publisher, of their present location. FIG. 2 illustrates this problem diagrammatically.

A number of devices 201, 202, 203, 204 and 205 form part of the Internet 101, each possibly being connected to a wireless hotspot, such as those described previously with respect to FIG. 1. Each one of these devices sends out requests whenever they require data of some form—for example, they may be requesting an initial webpage HTML document using HTTP, or may, having received that HTML document, be requesting further resources required to display the webpage correctly, such as images, video or advertising.

Most of these requests, such as request 206 issued by device 202, request 207 issued by device 203, request 208 issued by device 204, and request 209 issued by device 205, contain only information concerning the Internet-facing IP address of the client device, the device type, the browser type and so forth. However, (as found in research conducted by the present applicant), in around five percent of cases, requests may include geolocation data, such as request 210 issued by device 201. Device 201 can therefore be characterized as a locatable browsing client. In many cases, this geolocation data comprises latitude and longitude co-ordinates generated by GPS-based technology present in the device. Other geolocation data that can be provided includes orientation (provided by a magnetometer or a compass) and altitude (either provided by GPS or an altimeter).

Thus, at first sight, it may seem, therefore, that only five percent of requests can be responded to with content that is sympathetic to a device's location.

However, the present applicant has recognized that in the case of ISP-owned wireless hotspot, such as those operated in the context of FIG. 1 by ISPs 106, 110 and 114, location-aware content can be provided to any and all client devices. Each wireless hotspot, such as wireless hotspots 115, 116 and 117, utilizes some form of router to allow its connected client devices to access the Internet 101. Such routers often utilize Network Address Translation, such that devices connected on the local area network side of the router, whilst each having a distinct Internet Protocol (IP) address, appear from the wide area network side of the router to have the same IP address—the IP address of the router. Thus, referring to FIG. 1, it is clear from this knowledge that each one of the devices 103, 104 and 105 that are connected to ISP 106 will, from the perspective of publisher 102, appear to have the distinct originating IP address of the router operating the wireless hotspot operated by ISP 106. As the router is practically guaranteed to remain in a particular location, it is possible to therefore associate a particular location with a particular IP address, irrespective if the requests from the client devices themselves actually include geolocation data. In this way, location-specific content may be provided to all devices making advertisement requests comprising a particular IP address.

In addition, the location of all devices may be tracked, which, in an embodiment of the present invention, is performed so as to make an assessment as to the conversion rate of advertisements shown to the users of client devices.

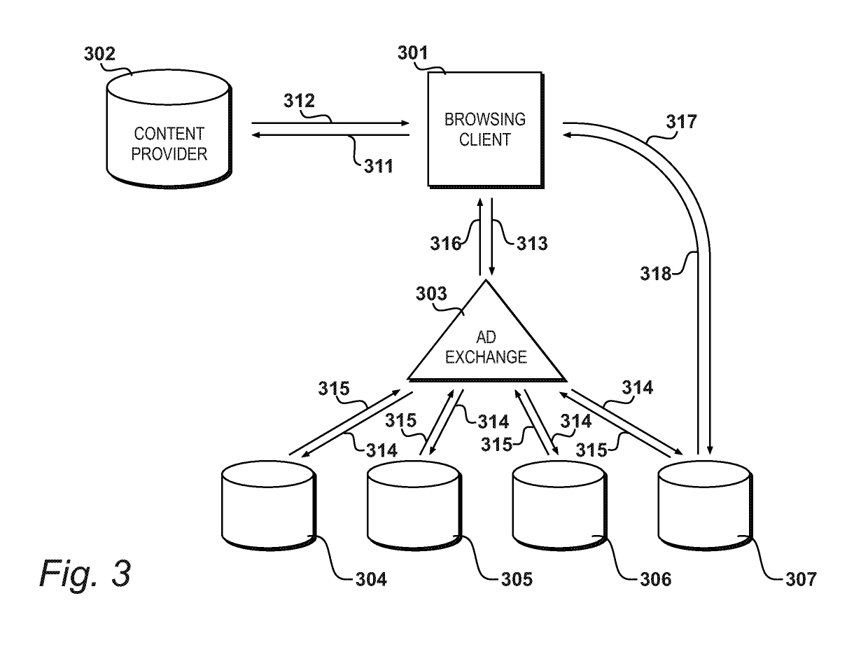

### FIG. 3

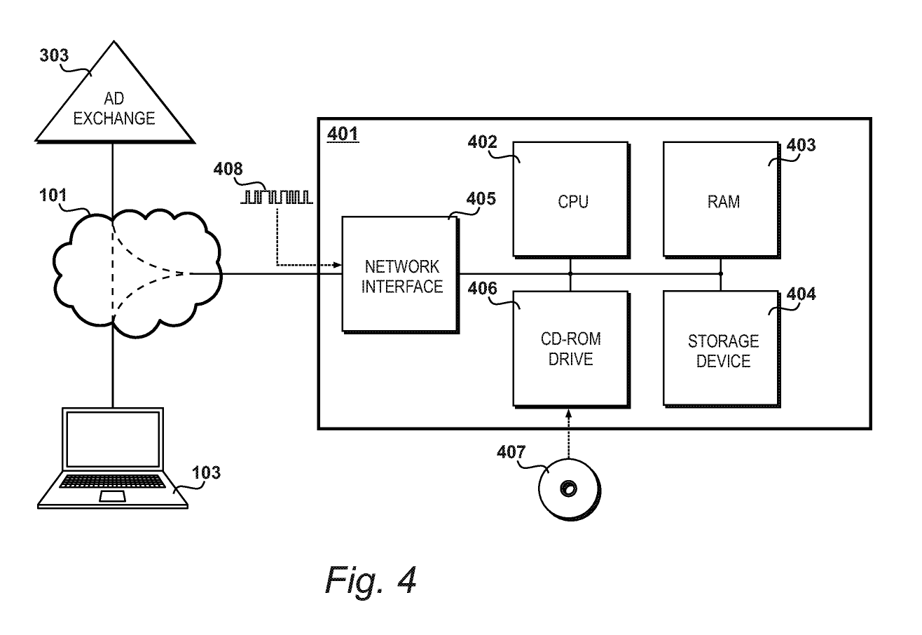

In the present embodiment, this is achieved by operating a computer within a Real Time Bidding environment for advertising of the known type, as shown in FIG. 3. The constituent components of such a computer will be expanded upon with reference to FIG. 4.

As will be appreciated by those skilled in the art, Real Time Bidding is a method of selling and purchasing advertising for display on a web page or within an application. This selling and purchasing is done in real time, and on a per-impression basis. Referring to FIG. 3, the way in which this operates will now be described.

A browsing client 301 makes a request at 311 for some content, such as a web page, from a publisher 302. The publisher supplies the HTML (or similar) for the web page to the browsing client at 312. Included in the code of the web page, is a pointer (known in the art as an “ad tag”) to resource hosted by an advertising exchange 303. Thus, at 313, the browsing client makes an advertisement request to the advertising exchange for the resource—i.e. the image or video to show as part of an advertisement on the web page. Importantly, this advertisement request to the advertising exchange includes data concerning the identity of the client and the publisher, and, as described previously with reference to FIG. 2, in a small proportion of cases this includes geolocation data.

After receiving this request, the advertising exchange 303 forwards the advertising requests at 314 to each one of a number of participants in the Real Time Bidding Environment—namely participants 304, 305, 306 and 307. This allows the participants to make an informed choice on the potential value of the advertising impression they are about to bid on. Each participant thus makes a decision as to whether to bid on the opportunity to present their advertising to the browsing client, and return their responses at 315. In this example, participant 307 wins the auction, and so advertising exchange 303 returns to browsing client 301 at 316 the location of a resource hosted by participant 307. At 317, browsing client 301 requests the resource (i.e. the data constituting an advertisement) from participant 307, which serves the data to the browsing client at 318.

### FIG. 4

Illustrated in FIG. 4 is an example of a computer apparatus that can be used by a participant in the Real Time Bidding environment described previously with reference to FIG. 3.

Thus, in this second embodiment, the apparatus is adapted to operate as a Real Time Bidding (RTB) computer 401. Upon receiving an advertising request from advertising exchange 303, appropriate bids on the advertising impression can be made by RTB computer 401.

In order for RTB computer 401 to execute instructions, it comprises a processor such as central processing unit (CPU) 402. In this instance, CPU 402 is a single multi-core Intel® Xeon® processor. It is possible that in other configurations several such CPUs will be present to provide a high degree of parallelism in the execution of instructions.

Memory is provided by eight gigabytes of DDR3 random access memory (RAM) 403, which allows storage of frequently-used instructions and data structures by RTB computer 401. A portion of RAM 403 is reserved as shared memory, which allows high speed inter-process communication between applications running on RTB computer 401.

Permanent storage is provided by a storage device such as hard disk drive 404, which in this instance has a capacity of one terabyte. Hard disk drive 404 stores operating system and application data. In alternative embodiments, a number of hard disk drives could be provided and configured as a RAID array to improve data access times, and the hard disk drive could be substituted with a solid-state disk.

A network interface 405 allows RTB computer 401 to connect to the Internet 101, possibly via an internal network and a router (not shown), and provide advertising content to a browsing client, such as client device 103 previously referenced with respect to FIG. 1, and also to receive advertising requests from advertising exchange 303. It will be appreciated that some of these advertising requests, as explained with reference to FIG. 2 and FIG. 3, will include geolocation data in addition to just the browsing client's IP address and identity of the publisher, etc. Network interface 405 also allows an administrator to interact with and configure web server 401 via another computer using a protocol such as secure shell.

RTB computer 401 also comprises an optical drive, such as a CD-ROM drive 406, into which an optical disk, such as a CD-ROM 407 can be inserted. CD-ROM 407 comprises computer-readable instructions that are installed on hard disk drive 404, loaded into RAM 403 and executed by CPU 402. Alternatively, the instructions (illustrated as 408) may be transferred from a network location using network interface 405. The instructions, when executed by the RTB computer 401, cause it to carry out the methods of the present invention.

It is to be appreciated that the above system is merely an example of a configuration of system that can fulfill the role of RTB computer 401. Any other system having a processor, memory, and a network interface could equally be used. Indeed, RTB computer 401 could be deployed as a virtual appliance on a virtualization platform hypervisor.

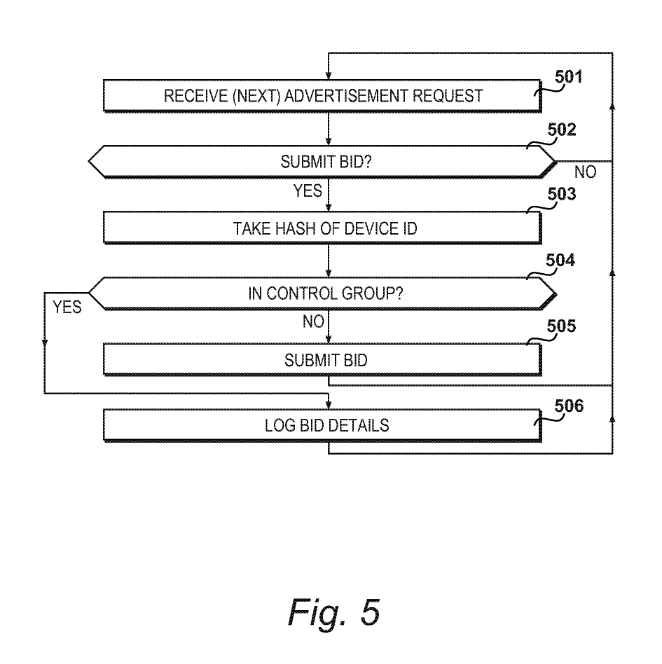

### FIG. 5

As described previously, it is possible to associate a particular IP address with a particular location, and the present applicant has developed sophisticated techniques for accurately making such associations, such as those described in Applicant's co-pending U.S. application Ser. No. ______ filed ______ (Attorney Docket No. 4113-P106-US), the whole contents of which are incorporated herein by reference.

The present invention may therefore utilize such data when participating in large real-time bidding environments, of which an example is shown in FIG. 3. In practice, such networks comprise many millions of browsing devices, and multiple RTB computers distributed on a global basis and configured in substantially similar ways to provide scale for the volume of advertisement requests being handled.

A problem is therefore encountered in terms of guaranteeing substantially the same operation as between the multiple RTB computers. Attempts can be made to mirror state between the multiple RTB computers, but as described previously, the real-time bidding process takes place over the order of milliseconds. Thus state synchronization is often not possible as the latency due to the geographical separation of the RTB computers makes it impractical or unreliable.

A particularly difficult operation to synchronize is the classification of devices by the RTB computers. For example, it may be desirable, as in the present invention, to display advertisements of one kind to one group of devices (a treatment group), and display advertisements of another kind or, as in the present embodiment, not at all to another group (a control group).

This is known as A/B testing and allows statistical analysis of the efficacy of an advertising campaign with reference to the further behavioral activity of a browsing device.

It is critical that each RTB computer classifies a particular device as part of the treatment group and control group every time it issues an advertisement request. The present invention therefore takes an approach which allows each RTB computer to arrive at a classification of a particular device independently from any other RTB computer. However, the method of doing so is deterministic, and so the aforesaid requirement is met.

Steps carried out by the RTB computer 401 when participating in a real-time bidding environment so as to perform A/B testing to evaluate the efficacy of an advertisement campaign, are set out in FIG. 5.

A new advertisement request is received from a publisher via the IP network at step 501, and a decision is then made at step 502 as to whether to submit a bid or not. This step may involve consideration of the device type, location, nature of resource being requested, time of day, etc. as will be understood by those skilled in the art, and will arrive at a monetary value to be submitted as the bid.

If a decision is made not to bid, the RTB computer 401 takes no further action and considers the next incoming advertisement request at step 501.

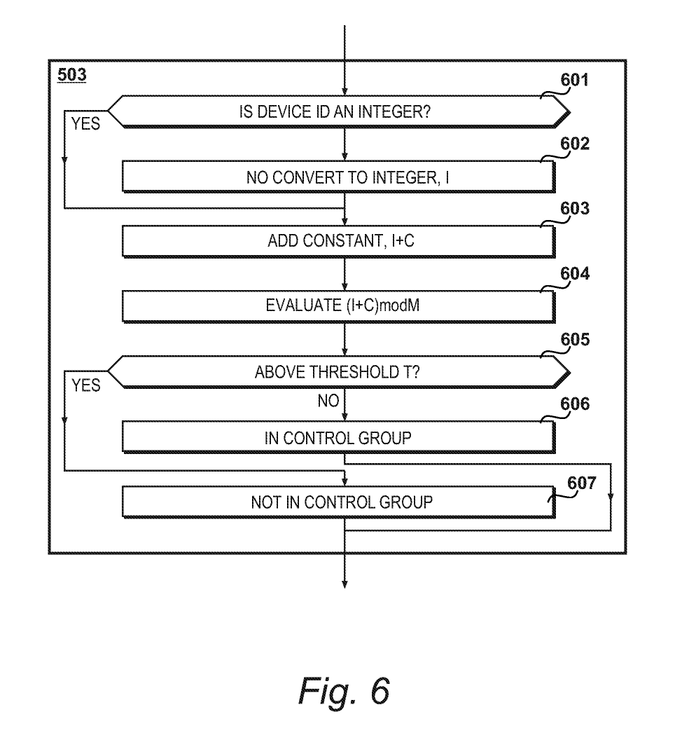

Alternatively, if a determination was made at step 502 to the effect that a bid should be entered, then the RTB computer proceeds to take a hash of the device identifier comprised within the advertisement request. As will be appreciated by those skilled in the art, in real-time bidding environments all advertisement requests include a unique identifier to uniquely identify the device submitting the advertisement request. The process of taking a hash will be described further with reference to FIG. 6.

By taking a hash of the device ID, a determination may be made as to whether the device is in the control group or not. Thus, following taking the hash at step 503, a question is asked at step 504 as to whether the hash signifies that the device is in the control group, or not. If not, then a bid is submitted at step 505 in response to the advertisement request. If so, then no bid is submitted and instead control proceeds to step 506 where the details of the bid that would have been submitted are committed to a log in memory. In this way, NB testing is implemented and is guaranteed to be carried out in the same way by any and all RTB computers distributed throughout the real-time bidding environment.

Step 506 allows an analysis to be made with respect to all advertisement requests that would or were bid upon, irrespective of whether the device was considered as part of the control group or not. This allows the present invention to be integrated into existing real-time bidding systems. Further, in the present embodiment, geolocation information embedded in the received advertisement requests is monitored so as to facilitate an assessment as to whether a particular advertisement shown on a particular device influenced the behavior of the device in terms of particular locales visited. The A/B testing provided by the method of the present invention allows normal behavior of a population to be inferred, and therefore allows the efficacy of an advertisement campaign in terms of conversions to be assessed. It is noteworthy that this is not possible with print advertisement, as there is no control over whether or not a particular person views or does not view, say, a billboard advertisement. The present invention therefore specifically deals with a problem and an opportunity provided by the nature of the technical environment in which it operates.

### FIG. 6

Steps carried out to take a hash of the device ID during step 503 are set out in FIG. 6.

A question is asked at step 601 as to whether the device ID set out in the advertising request is an integer. If not, then at step 602 it is converted to an integer I, possibly by using a base conversion method (in which an alphanumeric string is considered as a base 62 number and converted to base 10), or similar process.

Then, or if the device ID is already an integer, a constant C is added to the integer I to produce a shifted integer I+C at step 603. In the present embodiment, the constant C is a random 32-bit integer pre-shared amongst all RTB computers performing this method.

Then, at step 604, the shifted integer modulo a divisor M is evaluated, i.e. (I+C)modM. In the present example, the divisor M is 100, but depending upon the accuracy to which one wishes to split advertisement requests into control groups, this value can be varied. The result of step 604 is to produce a number between 0 and 99.

A question is then asked at step 605 as to whether the result of step 604 is above a threshold value T. This value is the proportion of advertisement requests that should be in the control group, and is calculated with reference to the divisor M. Thus in the present example, it is desired that 20 percent of advertisement requests get classified as in the control group. Thus, the threshold value T is set at 19 (recalling that step 604 produces values between 0 and 99). Along with the divisor M and the constant C, this value is shared amongst all RTB computers performing the method of the present invention.

If it is determined that the result of step 604 is below the threshold T, then at step 606 the advertisement request is classified as being in the control group. Alternatively, if it is determined that the result of step 604 is below the threshold T, then control proceeds to step 607 whereupon the advertisement request is classified as being in the treatment group and thus not in the control group.

In this way, advertisement requests originating from particular devices will always be classified into the same group, thereby facilitating the A/B testing for evaluate the efficacy of an advertisement campaign.

1. A method comprising performing A/B testing to evaluate the efficacy of an advertisement campaign, in which advertisements are shown to users of devices connected to an Internet Protocol (IP) network, the method comprising:
receiving an advertisement request via the IP network from a publisher connected to the IP network, wherein the advertisement request comprises information including a device identifier of a device requesting a resource from the publisher over the IP network;
determining whether to respond to the advertisement request or not on the basis of the information in the advertisement request, and
in response to determining to respond to the advertisement request, evaluating a hash of the device identifier to determine whether the device belongs to a control group or not; and
in response to determining that the device belongs to the control group, not responding to the advertisement request.

2. The method of claim 1, in which the hash is evaluated by:
converting the device identifier into an integer;
adding a constant to the integer to produce a shifted integer; and
performing a modulo operation on the shifted integer to produce a remainder.

3. The method of claim 2, in which the modulo operation comprises evaluating the remainder of the shifted integer after division by 100.

4. The method of claim 2, in which the constant is a random integer that is specific to a particular advertisement campaign.

5. The method of claim 2, in which the determination as to whether the device belongs to the control group or not is made by:
comparing the remainder to a threshold;
in response to the comparison identifying that the remainder is below the threshold, identifying the device as belonging to the control group; and
in response to the comparison identifying that the remainder is not below the threshold, identifying the device as not belonging to the control group.

6. The method of claim 1, further comprising a step of logging occasions on which it is determined that the device belongs to the control group.

7. The method of claim 1, further comprising a step of tracking the location of the device so as to determine whether the advertisement influences users' location behavior.

8. A non-transitory computer-readable medium having computer- readable instructions encoded thereon, in which said computer-readable instructions, when executed by a computer, cause the computer to perform a method comprising performing A/B testing to evaluate the efficacy of an advertisement campaign, in which advertisements are shown to users of devices connected to an Internet Protocol (IP) network, the method comprising:
receiving an advertisement request via the IP network from a publisher connected to the IP network, wherein the advertisement request comprises information including a device identifier of a device requesting a resource from the publisher over the IP network;
determining whether to respond to the advertisement request or not on the basis of the information in the advertisement request, and
in response to determining to respond to the advertisement request, evaluating a hash of the device identifier to determine whether the device belongs to a control group or not; and
in response to determining that the device belongs to the control group, not responding to the advertisement request.

9. The non-transitory computer-readable medium of claim 8, in which the hash is evaluated by:
converting the device identifier into an integer;
adding a constant to the integer to produce a shifted integer; and
performing a modulo operation on the shifted integer to produce a remainder.

10. The non-transitory computer-readable medium of claim 9, in which the modulo operation comprises evaluating the remainder of the shifted integer after division by 100.

11. The non-transitory computer-readable medium of claim 9, in which the constant is a random integer that is specific to a particular advertisement campaign.

12. The non-transitory computer-readable medium of claim 9, in which the determination as to whether the device belongs to the control group or not is made by:
comparing the remainder to a threshold;
in response to the comparison identifying that the remainder is below the threshold, identifying the device as belonging to the control group; and
in response to the comparison identifying that the remainder is not below the threshold, identifying the device as not belonging to the control group.

13. The non-transitory computer-readable medium of claim 8, in which said computer-readable instructions cause the computer to execute a further step of logging occasions on which it is determined that the device belongs to the control group.

14. The non-transitory computer-readable medium of claim 8, in which said computer-readable instructions cause the computer to execute a further step of tracking the location of the device so as to determine whether the advertisement influences users' location behavior
